(19) United States
(12) Patent Application Publication
(10) Pub. No.: US 2015/0158417 A1
(43) Pub. Date: Jun. 11, 2015

(54) Portable Illumination Brake and Indicator Lights Panel for Vehicle

(71) Applicant: Yehoshua Rahamim Levi, Ramat Gan (IL)

(72) Inventor: Yehoshua Rahamim Levi, Ramat Gan (IL)

(21) Appl. No.: 14/625,642

(22) Filed: Feb. 19, 2015

Related U.S. Application Data
(63) Continuation-in-part of application No. 13/487,204, filed on Jun. 3, 2012.

(30) Foreign Application Priority Data
Dec. 8, 2009 (IL) 202589
Dec. 6, 2010 (IL) PCT/IL2010/001028

(51) Int. Cl. B60Q 1/34; B60Q 1/44

(52) U.S. Cl. CPC B60Q 1/34; B60Q 1/44

(57) ABSTRACT

A portable and independent illumination panel for vehicles designed to issue a warning whenever the vehicle's brake or turn signal lights are activated, that comprises: a casing, an internal power source, a processing unit, a left turn indicator, a brake indicator, a right turn indicator, a left-hand sensor, a middle sensor, and a right-hand sensor. The middle sensor is of a kind that detects red light and when it detects red light it sends a signal to the said processing unit. When the processing unit receives said signal from the middle sensor, it issues a activation command to said brake indicator. The left-hand and the right-hand sensor is of a kind that detects yellow-orange light and when it detects yellow-orange light, it sends a signal to the said processing unit,

### RELATED APPLICATIONS

This application is a continuation in part of U.S. patent application Ser. No. 13/487,204 filed on 3 Jun. 2012, which claimed priority of a PCT application number PCT/IL2010/001028, filed on 6 Dec. 2010 that claims priority of Israeli patent application number 202589 filed on 8 Dec. 2009.

### TECHNICAL FIELD

The present invention relates to an illumination panel, which is designed to be attached to a vehicle and to correspond with the vehicle's turn signal lights and brake lights.

### BACKGROUND ART

Publication number US 2003/0231109 A1 (Kim) describes a brake light control system that includes two modules: a brake light assembly (motorcycle module) and a helmet module. The former is installed on the motorcycle and the latter is affixed on a helmet. The system, described in Kim, comprises a unit that is installed on the motorcycle and involves direct interference with the motorcycle's mechanisms, which poses difficulties and hinders the implementation and installation of the system on motorcycles, which is sometimes even forbidden in terms of transport laws. The present invention offers a response to these problems, mainly due to the fact that the system, subject of the present invention, comprises a single unit that is not connected to the motorcycle mechanisms or to the vehicle in which it is implemented.

### THE DRAWINGS

The intention of the figures attached to the application is not to limit the scope of the invention and its application. The figures are intended only to illustrate the invention and they constitute only one of its many possible implementations.

FIG. 1 depicts the illumination panel (100), the carrier (200) and a helmet (300).

FIG. 2 depicts the illumination panel (100) affixed on a helmet (300).

FIG. 3 depicts the illumination panel (100) with two clips (101).

FIG. 4 depicts the harness (400).

FIG. 5 depicts the illumination panel (100) and the harness (400) attached to the driver shoulders.

FIG. 6 depicts the illumination panel (100) and the harness (400).

FIG. 7 presents a schematic description of the illumination panel (100) that comprises a casing (105), a brake indicator (220), a left turn indicator (110), a right turn indicator (330), a processing unit (103), an internal power source (102), an internal charging mechanism (1020), a charging socket (1021), and three sensors (111) (222) (333), the sensor housings (104) with an openings (1040) and an inserted sensors.

### THE INVENTION

The present invention refers to an independent, wireless, portable illumination panel (100) for vehicles that is designed to illuminate so as to reflect the operation of the vehicle's standard brake lights and turn signal lights.

The illumination panel (100) can be installed on vehicles such as cars, trailers, motorcycles, and other such vehicles that are equipped with integral brake lights and turn signal lights (hereinafter “vehicles”). When the illumination panel (100) is used on a car, it may be affixed, for example, to the inner side of the rear window; when the system is used on a trailer, the illumination panel (100) may be affixed to the rear side of the trailer; and when it is used on a motorcycle, it can be affixed to the helmet or clothes of the driver or to the helmet or clothes of the passenger riding behind the driver.

The illumination panel (100) comprises a casing (105), an internal power source (102), a processing unit (103), three indicators—left turn indicator (110), brake indicator (220), and right turn indicator (330), and three sensors—left-hand sensor (111), middle sensor (222), and right-hand sensor (333).

The turn indicators (110), (330) and the brake indicator (220) can be any kind of indicator light, although they can and should be LED type lights. The brake indicator (220) is located in the center of the illumination panel (100) and it should be red, like the standard brake light of a vehicle. The left turn indicator (110) is located on the left-hand side of the illumination panel (100) and it should be yellow-orange, like a standard turn signal light of a vehicle. The right turn indicator (330) is located on the right-hand side of the illumination panel (100) and it also should be yellow-orange, like a standard turn signal light of a vehicle. Although we use the expressions “red light” and “yellow-orange light” in the present application since these are the colors commonly used for vehicle brake and turn signal lights, the present patent application refers to any variety of possible indicator colors.

The internal power source (102) can be, for instance, a regular internal battery or a rechargeable replaceable battery. The illumination panel (100) may also be equipped with an internal charging mechanism (1020) that may be charged using an external charger that is plugged into a socket (1021) on the illumination panel (100).

The sensors (111) (222) (333) are sensors that detect light in the relatively short range, up to about 2 meters. The left-hand sensor (111) and the right-hand sensor (333) are each inserted into hollow sensor housings (104) with an opening (1040), such that the opening (1040) of the housing (104) into which the left-hand sensor (111) is inserted is directed toward the rear, left-hand side of the vehicle, and the opening (1040) of the housing (104) into which the right-hand sensor (333) is inserted is directed toward the rear, right-hand side of the vehicle. The three sensors (111) (222) (333) may protrude from the illumination panel (100) through their corresponding openings so that they face the desired direction, as mentioned above.

The purpose of using sensor housings (104) into which the left-hand sensor and the right-hand sensor are inserted is to prevent light from the vehicle's right turn signal light to affect the left-hand sensor, and to prevent light from the vehicle's left turn signal light to affect the right-hand sensor. Thus, when the left turn signal light is on, the left-hand sensor is more strongly affected by the signal light than is the right-hand sensor since the opening (1040) of the sensor housing (104) into which the right-hand sensor (333) is inserted faces away from the vehicle's left turn signal light while the opening (1040) of the sensor housing (104) into which the left-hand sensor (111) is inserted faces toward the vehicle's left turn signal light; hence the left-hand sensor (111) is more affected than the right-hand sensor (333). The processing unit (103) includes an algorithm that processes the intensity of the signal obtained from the two sensors (111) (333), and when the intensity of signal obtained from the left-hand sensor is greater than that obtained from the right-hand sensor, the processing unit (103) issues an activation command for the left turn indicator (110), and vice versa. The role of the sensor housings (104) and the aforementioned algorithm is to prevent a situation in which the effect of the vehicles right turn signal light on the left-hand sensor causes the left turn indicator (110) to be illuminated, and vice versa.

The internal power source (102) is connected to the brake and turn indicators (110) (220) (330), to the sensors (111) (222) (333), and to the processing unit (103), and powers them all. The processing unit (103) is connected to all three indicators (110) (220) (330), and controls their operation according to signals received from the sensors (111) (222) (333).

The processing unit (103) includes, as mentioned, an algorithm that does the following operations: when the middle sensor (222) detects a red light at the rear of the vehicle, it sends a signal to the processing unit (103), which in turn issue an activation command to the brake indicator (220), which then illuminates. When the middle sensor (222) stops sending a signal, the processing unit issues a deactivation command to the brake indicator (220), which turns off The same is true for the left-hand sensor and the right-hand sensor, which lead to the activation and deactivation of the left turn indicator and right turn indicator, respectively.

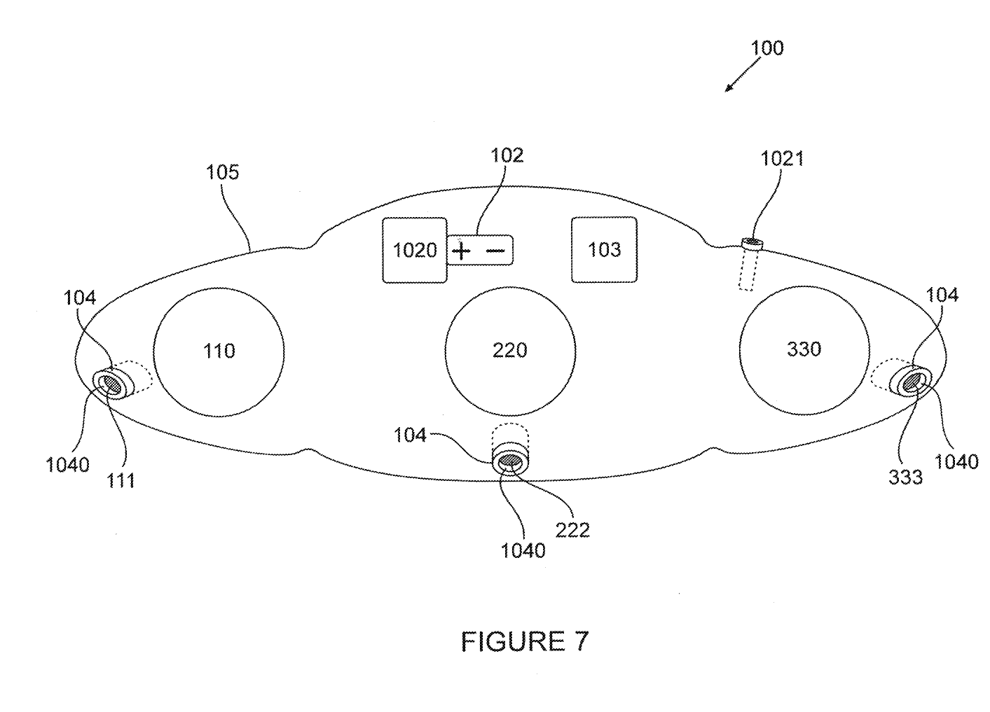

FIG. 7 presents a schematic description of the illumination panel (100) that comprises a casing (105), a brake indicator (220), a left turn indicator (110), a right turn indicator (330), a processing unit (103), an internal power source (102), an internal charging mechanism (1020), a charging socket (1021), and three sensors (111) (222) (333). FIG. 7 also depicts the sensor housings (104) with openings (1040) and inserted sensors.

The sensors (111) (222) (333) are located on the illumination panel (100), which detects the activation or deactivation of the vehicle's turn signal lights and brake lights and, accordingly, sends a signal to the processor unit (103), which then issues an activation or deactivation command to the turn indicators (110) (330) or brake indicator (220) on the illumination panel (100). Thus, there is no need to tamper with and/or connect to the vehicle or any of its parts or existing systems. These sensors function by filtering the constant background light (such as sunlight, street lights, and so on).

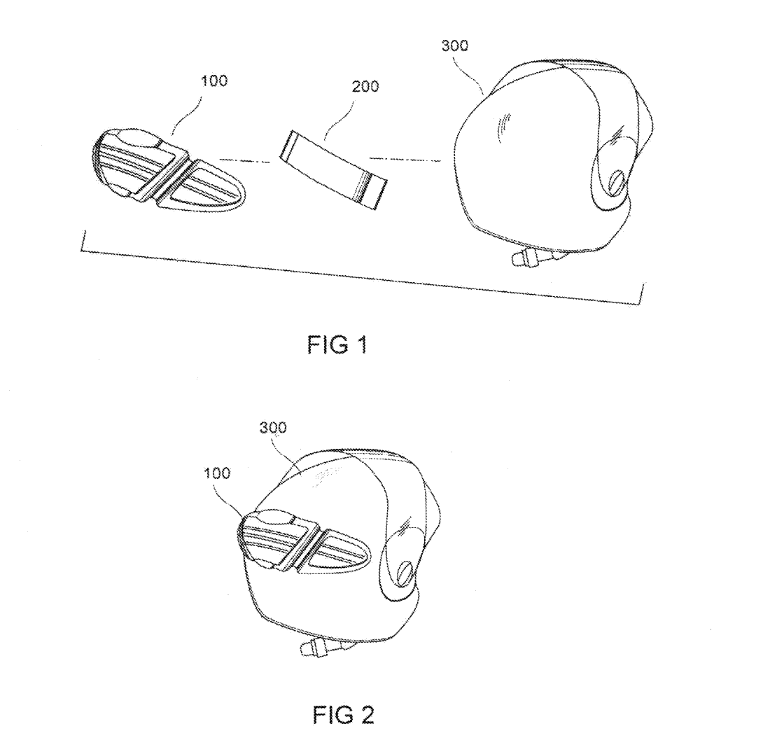

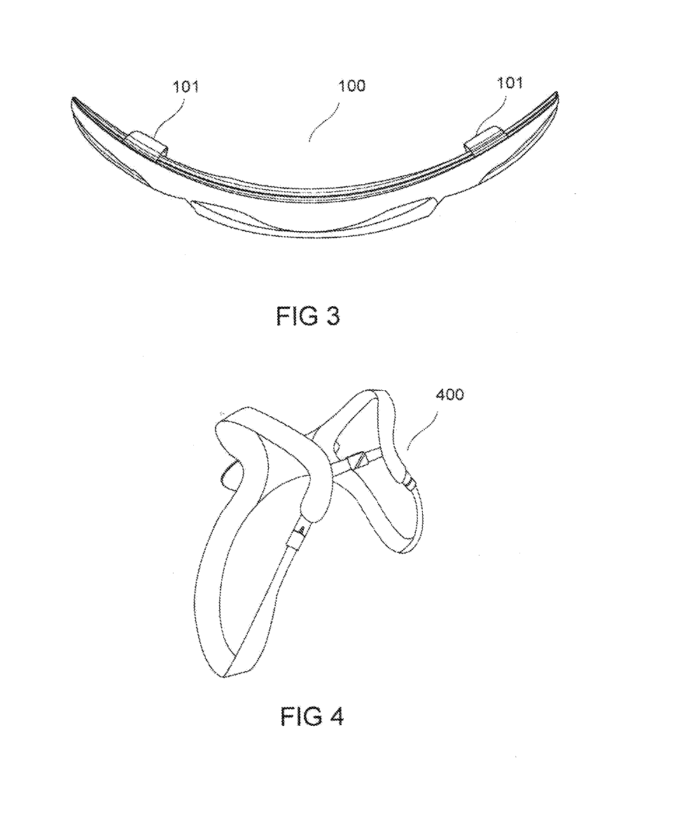

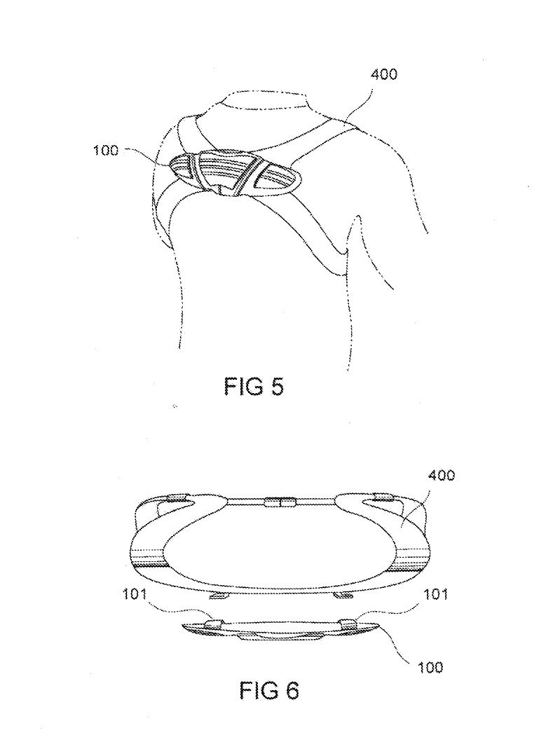

The illumination panel (100) can be affixed to any kind of a surface such as a rear window of a car, a back side of a trailer, or a helmet (300), by means of a carrier (200). The carrier is in fact a plate made of metal or plastic or any other rigid material. The carrier (200) can be affixed to the proper surface using double-sided sticky tape. Thus, the illumination panel (100) can be affixed by attaching it to the carrier, with no need for complex and complicated adjustments. The upper interior part of the illumination panel (100) may include two clips (101) that enable it to be attached to the carrier (200). It is also possible to use a harness (400) that the driver (or passenger seated behind) can wear on his or her shoulders. The illumination panel (100) can be affixed to the harness (400) using the two clips (101). FIG. 1 depicts the illumination panel (100), the carrier (200) and a helmet (300). FIG. 2 depicts the illumination panel (100) affixed on a helmet (300). FIG. 3 depicts the illumination panel (100) with two clips (101). FIG. 4 depicts the harness (400). FIG. 5 depicts the illumination panel (100) and the harness (400) attached to the driver shoulders. FIG. 6 depicts the illumination panel (100) and the harness (400).

What is claimed is:

1. A portable and independent illumination panel for vehicles designed to issue a warning whenever the vehicle's brake or turn signal lights are activated, that comprises: a casing, an internal power source, a processing unit, a left turn indicator, a brake indicator, a right turn indicator, a left-hand sensor, a middle sensor, and a right-hand sensor; wherein the middle sensor is of a kind that detects red light and when it detects red light it sends a signal to the said processing unit; whereby when the processing unit receives said signal from the middle sensor, it issues a activation command to said brake indicator; wherein the left-hand sensor is of a kind that detects yellow-orange light and when it detects yellow-orange light, it sends a signal to the said processing unit; wherein the left-hand senor faces the rear left-hand side of the vehicle; wherein the right-hand sensor is of a kind that detects yellow-orange light and when it detects yellow-orange light, it sends a signal to the said processing unit; wherein the right-hand sensor faces the rear right-hand side of the vehicle; wherein the processing unit includes an algorithm that compares the intensity of the signals received from the left-hand and right-hand sensors; wherein the processing unit issues an activation command to the left turn indicator when the intensity of the signal received from the left-hand sensor is stronger than that received from the right-hand sensor;
and wherein the processing unit issues an activation command to the right turn indicator when the intensity of the signal received from the right-hand sensor is stronger than that received from the left-hand sensor.

2. The illumination panel mentioned in claim 1 whereby it is also equipped with a sensor housing with an opening into which said left-hand sensor is inserted; wherein the opening faces the rear, left-hand side of the vehicle; wherein it is also equipped with a sensor housing with an opening into which said right-hand sensor is inserted; wherein the opening faces the rear, right-hand side of the vehicle.
